(19) United States
(12) Patent Application Publication
(10) Pub. No.: US 2021/0189662 A1
(43) Pub. Date: Jun. 24, 2021

(54) ARTIFICAL GRASS

(71) Applicant: GO GREEN SYNTHETIC LAWN SOLUTIONS, LLC, Tunnel Hill, GA (US)

(72) Inventor: DAVID M. DAVIS, JR., TUNNEL HILL, GA (US)

(21) Appl. No.: 16/723,187

(22) Filed: Dec. 20, 2019

(51) Int. Cl. E01C 13/08; A41G 1/00

(52) U.S. Cl. CPC E01C 13/08; A41G 1/009

(57) ABSTRACT

The present invention relates to a face spinneret and/or nylon face fiber having a certain shape and dimension which impart improved characteristics to the fiber, such a softer feel and a reduced sheen. In another embodiment, the invention is directed to a thatch spinneret and/or nylon thatch fiber having a certain shape and dimension which impart improved characteristics to the fiber, such a softer feel and a reduced sheen.

### FIELD OF THE INVENTION

The present invention relates generally to an artificial grass product and a method for making the same.

### SUMMARY OF THE INVENTION

In an embodiment, the invention is directed to a face spinneret and/or nylon face fiber having a certain shape and dimension which impart improved characteristics to the fiber, such a softer feel and a reduced sheen. In another embodiment, the invention is directed to a thatch spinneret and/or nylon thatch fiber having a certain shape and dimension which impart improved characteristics to the fiber, such a softer feel and a reduced sheen.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of a yarn of artificial grass in accordance with one embodiment of the invention;

FIG. 2 is a perspective view of a yarn of artificial grass in accordance with another embodiment of the invention;

FIG. 3 is a top view of a spinneret of the invention, the yarn shown in FIG. 1 having the same cross-sectional shape;

FIG. 4 is a top view of a spinneret of the invention, the yarn shown in FIG. 2 having the same cross-sectional shape;

FIG. 5 is a perspective view of an artificial grass product, including yarns and backing, in connection with an embodiment of the present invention; and

FIG. 6 is a perspective view of an artificial grass product, including yarns and backing, in connection with an embodiment of the present invention.

Elements illustrated in the figures are not necessarily drawn to scale. Repeat use of reference characters in the present specification and drawings is intended to represent the same or analogous features or elements of the invention.

### DETAILED DESCRIPTION OF PREFERRED EMBODIMENTS

Reference will now be made in detail to embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

In an embodiment, the artificial grass product of the present invention comprises nylon. Nylon has a high melt temperature and is resilient under deformation (i.e. it tends to retain its deformed shape). However, nylon typically does not inherently have a soft, grass-like feel underfoot and has a sheen that causes it to appear too shiny and unnatural. Accordingly, polypropylene and polyethylene are typically utilized for artificial grass products. Alternatively, currently, nylon may be chemically modified to provide a product with a softer feel and a more natural appearance. Though hard work and ingenuity, however, the present inventor has developed a nylon artificial grass product which has a soft feel and a natural appearance without chemical modification of the nylon itself. In an embodiment, the nylon yarns of the present invention achieve their characteristics and advantages due to their physical form, shape, and dimensions.

In an embodiment, the artificial grass product of the present invention at least partially comprises nylon. In an embodiment, artificial grass product of the present invention comprises 100% nylon. In an embodiment, the nylon has not been chemically modified. In an embodiment, the invention comprises both face fibers and thatch fibers and both the face fibers and the thatch fibers of the invention comprise nylon.

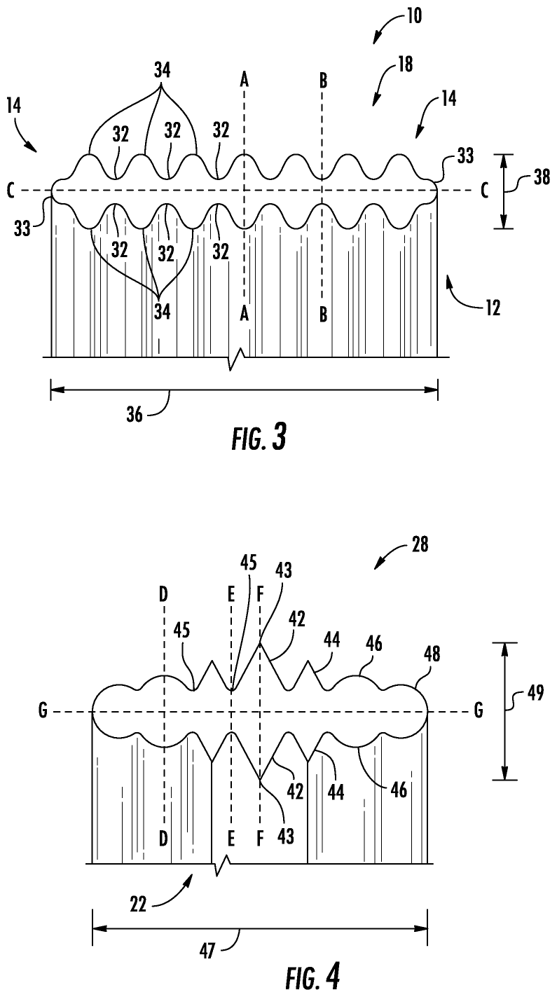

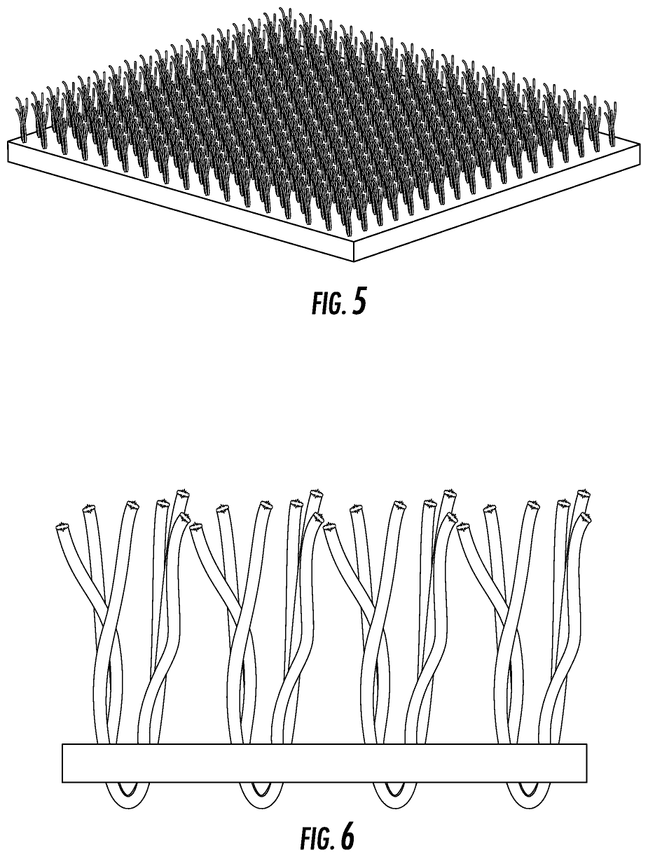

In an embodiment, the fibers of the artificial grass product of the invention are produced via a specific spinneret profile (exemplary embodiments shown in FIGS. 3 and 4), to provide a yarn with a soft feel and a reduction in sheen. In an embodiment, the fibers of the artificial grass product of the invention are provided with particular dimensions that aid in improving the feel and appearance of the turf. In a further embodiment, the face fibers and the thatch fibers of the invention have different textures and optionally different heights. In an embodiment, neither the face fiber nor the thatch fiber of the invention is flat.

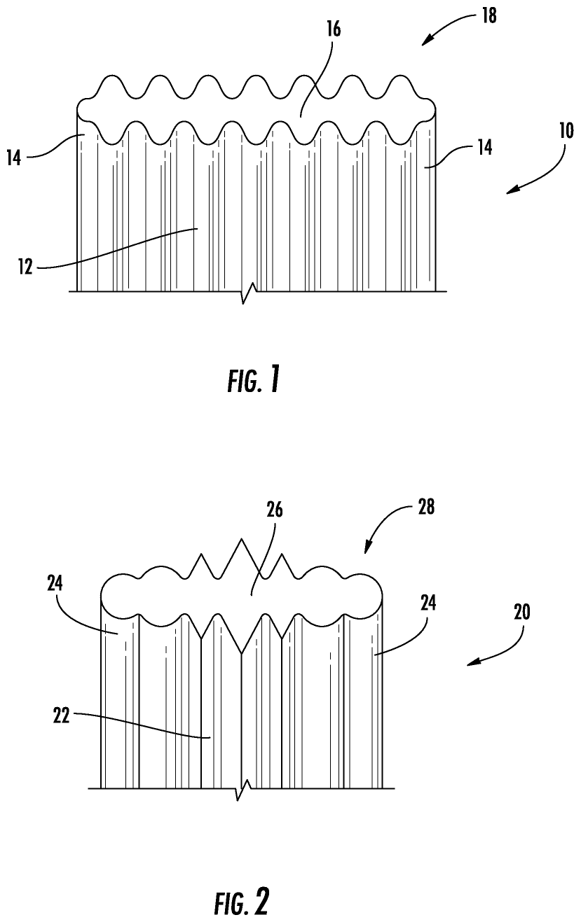

Referring to the drawings, FIGS. 1 and 2 illustrate embodiments of fibers of the present invention. In an embodiment, the fiber 10 shown in FIG. 1 may be utilized as a face fiber and the fiber 20 shown in FIG. 2 may be utilized as a thatch fiber. As shown, each fiber 10, 20 may have a first or front longitudinal face 12, 22, a second or rear longitudinal face 18, 28, a top surface 16, 26, and two ends 14, 24. In an embodiment, the fibers 10, 20 are extruded as a monofilament and the monofilament ribbon is cut in discrete lengths to form the fibers. For example, the top surface 16, 26 may represent a position where the ribbon was cut into a fiber.

FIGS. 3 and 4 illustrate top views of spinnerets used to extrude the fibers illustrated in FIGS. 1 and 2, respectively. Thus, in an embodiment, a cross-sectional view of the fibers illustrated in FIGS. 1 and 2 is the same as or very similar to the illustration of the spinnerets shown in FIGS. 3 and 4.

Generally speaking, the face spinneret (FIG. 3) and the cross-sectional view of the face fiber 10 of the invention comprises an elongated shape. In an embodiment, the face spinneret and the face fiber 10 do not comprise any linear or planar surfaces, viewed in cross-section. That is, in this embodiment, the perimeter or exterior surface of the yarn 10, as viewed in cross-section, comprises a continuous arcuate shape, alternating between concave 32 and convex portions 34. Thus, a convex portion 34 may continue into a concave portion 32, which may continue into a convex portion 34, repeating the pattern continuously. In an embodiment, the shape of the perimeter of the face fiber, and the perimeter of the face spinneret, may be described as having a sine curve-like shape.

In an embodiment shown in FIG. 3, the ends 14 of the face fiber, as viewed in cross-section, may each be convex, extending arcuately outwardly (each, a convex end portion 33). Adjacent each side of each convex end portion 33 may be a concave portion 32. In an embodiment, the convex end portions 33 extend outward in the width direction, away from the centerline A-A of the fiber width 36. The convex end portions 33 provide a soft feel to the edge of each end 14 of the synthetic grass blade, which is beneficial regardless of whether an individual is walking over a lawn or sliding over the turf in an athletic event. In an embodiment, the line C-C shown in FIG. 3 may be referred to as the longitudinal direction. In an embodiment, the convex end portions 33 extend outwardly in the longitudinal direction. In an embodiment, the concave portions 32 on either side of each convex end portion 33 transition from the convex end portion 33 to a plurality of convex and concave body portions.

As noted, in an embodiment, the face fiber 10 additionally comprises a plurality of convex body portions 34 which extend arcuately outwardly from the first side 12 of the face fiber and which are disposed along the width 36 of the fiber and are disposed at a ninety-degree angle (or approximately at a ninety-degree angle) from that of the convex end portions 33. In an embodiment, the convex body portions 34 extend outwardly from the first side 12, perpendicular to the longitudinal direction C-C. In an embodiment, the convex body portions 34 extend in the thickness direction, away from the center C-C of the fiber thickness 38.

In an embodiment, the face fiber 10 additionally comprises concave body portions 32 which may have the same or a similar (but opposite) radius of curvature as the convex portions 34 of the face fiber 10. In an embodiment, each concave portion 32 is adjacent a convex portion 34 along the first side 12 of the fiber 10. In an embodiment, each convex portion 34 of the face fiber 10 curves gradually into the adjacent concave portion 32 and vice versa.

As shown in FIG. 3, the convex portions 34 may be disposed opposite (relative to the width 36 of the face fiber 10) another convex portion 34. That is, line A-A is taken through the width 36 of the face fiber 10 and intersects a convex portion 34 on each side of the width 36. Likewise, the concave portions 32 may be disposed opposite (relative to the width 36 of the face fiber 10) another concave portion 32. That is, line B-B is taken through the width 36 of the face fiber 10 and intersects a concave portion 32 on each side of the width 36. In this embodiment, the protrusions (i.e. convex portions 34) are not staggered but are, instead, aligned along the width 36 (or the longitudinal direction C-C) of the face fiber 10. In an embodiment, the cross-section of the face fiber 10, including its convex and concave portions 32, 34, is symmetrical. In an embodiment, the centerline (shown as A-A in FIG. 3) comprises a convex portion 34 on each side of the width 36. In an embodiment, the face fiber 10 comprises four convex portions 34 between the centerline A-A and the end 14, not counting the convex end portion 33. In an embodiment, the face fiber 10 comprises five concave portions 32 between the centerline A-A and the convex end portion 33. In an embodiment, the face fiber 10 comprises nine convex portions 34 between the first end and the second end of the fiber. The sine curve-like structure of the perimeter of the yarn 10 provides a soft feel and reduction in luster, providing a more natural appearance and feel.

In an embodiment, the yarn shown in FIG. 1 comprises a face fiber 10 and the face spinneret (FIG. 3) and the face fiber each have a thickness 38 in the range of about 0.001 to 0.100 inches. In another embodiment, the yarn shown in FIG. 1 comprises a face fiber 10 and the face spinneret and yarn each have a thickness 38 in the range of about 0.025 to 0.033 inches. In still another embodiment, the yarn shown in FIG. 1 comprises a face fiber 10 and the face spinneret and yarn have a thickness 38 of about 0.025 inches.

In an embodiment, the yarn shown in FIG. 1 comprises a face fiber 10 and the face spinneret and yarn have a width 36 in the range of about 0.070 to 0.250 inches. In an embodiment, the yarn shown in FIG. 1 comprises a face fiber 10 and the face spinneret and yarn have a width 36 in the range of about 0.109 to 0.180 inches. In yet an embodiment, the yarn shown in FIG. 1 comprises a face fiber 10 and the face spinneret and yarn have a width 36 of about 0.180 inches.

In an embodiment, the yarn shown in FIG. 2 comprises a thatch fiber 20. In an embodiment, the thatch fibers 20 provide structural support to the face fibers 10. In another embodiment, the thatch fibers 20 provide a varied appearance and feel to the turf, simulating the look and feel of natural grass.

Generally speaking, a cross-sectional view of the thatch yarn 20 of the invention comprises an elongated shape, though not as elongated as that of the face yarn 10 in an embodiment. In an embodiment, the width of the face yarn 10 may be about one and a half times that of the thatch yarn 20. In an embodiment, the thatch yarn 20 is different from the face yarn 10 in at least one of thickness, width, and shape configuration.

In an embodiment, the thatch yarn 20 comprises a combination of linear or planar surfaces and curved surfaces, when viewed in cross-section. In an embodiment of the thatch spinneret shown in FIG. 4, the spinneret and resulting thatch fiber 20 comprise a longitudinal direction shown as G-G and a centerline shown as F-F. At the centerline F-F, the thatch fiber 20 may extend angularly outwardly from the first side 22 of the fiber 20, the extension being perpendicular to and away from the longitudinal direction G-G. In an embodiment, this first or central angular protrusion 42 may comprise a generally triangular shape or may be a flattened triangle, such that the outermost end of the triangle is flattened and is parallel to the longitudinal direction. In an embodiment, the angle of each side of the central angular protrusion 42 is equal. In an embodiment, a symmetrical central angular protrusion 42 is disposed on the second side 28 of the width of the yarn 20. In an embodiment, the end 43 of each central angular protrusion 42 comprises the thickest part of the thatch yarn 20. That is, the central angular protrusion 42 extends further away from the longitudinal direction G-G than any other part of the thatch yarn 20.

In an embodiment, one or more second angular protrusions 44 may extend perpendicular to and away from the longitudinal direction G-G. In an embodiment, a second angular protrusion 44 is disposed adjacent each side of the central angular protrusion 42, on a first side 22 of the thatch yarn 20. In an embodiment, the one or more second angular protrusions 44 may comprise triangular shapes or may be flattened triangles, such that the outermost end of the triangle is flattened and is parallel to the longitudinal direction. In an embodiment, the angle of each side of the second angular protrusions 42 is equal. In an embodiment, each of the second angular protrusions 42 has the same size, angles, and dimensions. In an embodiment, one or more second angular protrusions 42 are disposed on the second side 28 of the width of the yarn 20, symmetrically with those of the first side. In an embodiment, the width of the one or more second angular protrusions 44 may be less than the width of the central angular protrusion 42.

Adjacent each second angular protrusions 44, moving toward the end 24 of the fiber 20 in a cross-sectional dimension, the thatch fiber 20 may comprise one or more convex thatch portions 46. The convex thatch portions 46 may be continuously curved or may comprise a series of angles which appears to the naked eye to comprise a curvature. For example, the perimeter of the convex thatch portions 46 may comprise a smooth curve or may comprise three of more linear panels which appear to approximate a curve. The middle panel of the convex thatch portions 46 may be flattened and may be parallel with the longitudinal direction G-G, in an embodiment. For example, in an embodiment, the convex thatch portions 46 may comprise half-hexagonal shapes. In an embodiment, the width of the convex thatch portions 46 may be less than the width of the one or more second angular protrusions 44.

Finally, the thatch fiber 20 may comprise a bulbous end portion 48 on each longitudinal end 24 of the fiber. The bulbous end portions 48 may be semi-circular in an embodiment, curving convexly outwardly. In another embodiment, the bulbous end portions 48 may comprise a plurality of angular panels which approximate the appearance of a curvature. For example, the bulbous end portions 48 may be semi-hexagonal or semi-octagonal. In an embodiment, the width of the bulbous end portions 48 may be less than the width of the one or more convex thatch portions 46.

As shown in FIG. 4, the apex of each angular protrusion 42, 44 on the first side 22 of the fiber 20 may be disposed opposite (relative to the width 47 of the thatch fiber 20) the apex of another angular protrusion 42, 44 on the second side 28 of the fiber 20. That is, line F-F, is taken through the width 47 of the thatch fiber 20, intersects the apex of each central angular protrusion 42 on each side of the width 47.

Likewise, the convex thatch portions 46 on the first side 22 of the fiber 20 may be disposed opposite (relative to the width 47 of the thatch fiber 20) another convex thatch portions 46 on the second side 28 of the fiber 20. That is, line D-D is taken through the width 47 of the thatch fiber 20 and intersects the center of a convex thatch portion 46 on each side of the width 47. As can be seen, the valleys 45 between each angular protrusion 42, 44, convex thatch portion 46, and/or bulbous end portions 48 are also aligned and are not staggered, in an embodiment.

In this embodiment, the angular protrusions 42, 44 and the convex thatch portions 46 are not staggered but are, instead, aligned along the width 47 (or the longitudinal direction G-G) of the thatch fiber 20. In an embodiment, the cross-section of the thatch fiber 20, including its angular protrusions 42, 44, convex thatch portions 46, and bulbous end portions 48, is symmetrical. In an embodiment, thatch fiber 20 comprises, per longitudinal side, one central angular protrusion 42, two second angular protrusions 44 on either side of the central angular protrusion 42, convex thatch portions 46 on either side of the second angular protrusions 44, and two bulbous end portions 48 on each end 24 of the fiber. The variations in curvature and angularity of the thatch yarn 20 provides a reduction in luster and variance in visual appearance, providing a more natural appearance and feel to the artificial turf product.

In an embodiment, the yarn shown in FIG. 2 comprises a thatch fiber 20 and the thatch spinneret and yarn have a thickness 49 in the range of about 0.001 to 0.100 inches. In another embodiment, the yarn shown in FIG. 3 comprises a thatch fiber 20 and the thatch spinneret and yarn have a thickness 49 in the range of about 0.025 to 0.033 inches. In still another embodiment, the yarn shown in FIG. 2 comprises a thatch fiber 20 and the thatch spinneret and yarn have a thickness 49 of about 0.033 inches.

In an embodiment, the thickness of the thatch fiber 20 is variable along its width. That is, near the ends 24, the thatch fiber may be less thick then near the center of the fiber. In the central portion of the thatch fiber 20, the fiber may be thicker than the remainder of the fiber. In an embodiment, the thickness of the thatch fiber (or its extensions) increases gradually from the ends 24 to the central portion of the fiber.

In an embodiment, the yarn shown in FIG. 2 comprises a thatch fiber 20 and the thatch spinneret and yarn have a width 47 in the range of about 0.070 to 0.250 inches. In an embodiment, the yarn shown in FIG. 2 comprises a thatch fiber 20 and the thatch spinneret and yarn have a width 47 in the range of about 0.109 to 0.180 inches. In yet an embodiment, the yarn shown in FIG. 2 comprises a thatch fiber 20 and the thatch spinneret and yarn have a width 47 of about 0.109 inches.

In an embodiment, the yarn shown in FIG. 1 comprises a face fiber 10 and has a thickness 38 of about 0.025 inches and a width 36 of about 0.180 inches. In an embodiment, the face fiber has a width 36 that is approximately seven times greater than its thickness 38, at the greatest point of its thickness. In an embodiment, the yarn shown in FIG. 2 comprises a thatch fiber 20 and the thatch spinneret and yarn have a thickness 49 of about 0.033 inches, at its widest point, and has a width 47 of about 0.109 inches. In an embodiment, the thatch fiber 20 has a width 47 that is approximately three times greater than its thickness 49, at the greatest point of its thickness. In an embodiment, the face fiber of the invention has a greater width than that of the thatch fiber. In an embodiment, the face fiber of the invention has a lesser thickness width than that of the thatch fiber—that is the face fiber is a thinner fiber than that of the thatch fiber.

In an embodiment, the height of the face fibers is greater than the height of the thatch fibers. The height is determined from the upper surface of the backing to the top of the extended fibers, in a normal state of the turf. In an embodiment, the face and thatch fibers are upright-oriented cut-pile fibers and may be arranged in bundles of synthetic grass fibers. In an embodiment, face yarns and thatch yarns may be tufted together in a given bundle of fibers. In other embodiments, face yarn bundles and thatch yarn bundles may be tufted in adjacent, but alternating locations. In still other embodiments, face yarn bundles and thatch yarn bundles may be tufted in seemingly random locations. In such an embodiment, they are not necessarily present in adjacent, alternating positions.

Advantageously, the invention having the disclosed shapes, configurations, and dimensions provides good flexing and bending characteristics, a soft feel, a natural look, and durability. In an embodiment, the artificial turf invention described herein may be used on sports fields, artificial residential or commercial lawns, or for any other use known in the art.

In an embodiment, the synthetic grass product of the invention comprises at least two yarn ends, the yarn provided on a cone to be tufted through backing as face fabric or thatch fabric tufts. In an embodiment, the synthetic grass product of the invention is a single yarn. In another embodiment, the invention comprises multiple inventive yarns (optionally of varied colors) directed through the same opening of a backing material. Similarly, in an embodiment, the synthetic grass product of the invention comprises a roll or sheet of artificial grass tufted through a backing. In an embodiment, the backed synthetic grass product of the invention comprises face fiber tufts and thatch fiber tufts. In an embodiment, face fiber tufts are disposed adjacent thatch fiber tufts in the backing.

In an embodiment, the face fiber tufts comprise a plurality of filaments or strands. In an embodiment, the face fiber tufts comprise a plurality of filaments or strands which are different colors. In an embodiment, the thatch fiber tufts comprise a plurality of filaments or strands. In an embodiment, the thatch fiber tufts comprise a plurality of filaments or strands which are different colors. In an embodiment, a plurality of yarns (face or thatch) are tufted through the same opening in the backing material. In an embodiment, the melting point of the synthetic grass product of the invention is above 420 degrees Fahrenheit.

In an embodiment, the backed turf product of the invention has a pile height of at least about 0.6 inch. In another embodiment, the backed turf product of the invention has a pile height of at least about 1.0 inch. In an embodiment, the extruded ribbons of the invention may comprise between about 300 and 2500 denier. In another embodiment, the extruded ribbons of the invention may comprise between about 600 and 2000 denier.

Method:

In an embodiment, the method includes, not necessarily in this order, the following steps: extruding a pellet through a spinneret to form an extended ribbon; optionally, combining the extended ribbon with a blend of other extruded ribbons; cutting the extended ribbon(s) to create a yarn that has a specified length; and tufting the yarns into a backing material. In an embodiment, the pellet is a nylon material. In an embodiment pellets of varied colors are used to create ribbons and, thereby, yarns having differing colors. The backing material may include a foam pad and/or a subsurface in some embodiments. A fill material may be added on top of the backing if desired. While the invention is described as being tufted, the inventive yarns may alternatively be used in a woven or knitted artificial grass product.

The accompanying figures are provided for explanatory purposes. The components that are illustrated are not necessarily drawn to scale. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A nylon artificial turf comprising:
a plurality of face fibers which comprise a first longitudinal surface, a second longitudinal surface opposite the first longitudinal surface, a first end connecting the first longitudinal surface and the second longitudinal surface, a second end opposite the first end the first longitudinal surface and the second longitudinal surface, and a top surface, wherein:
the first end and the second end are convex; and
the first longitudinal surface and the second longitudinal surface each comprise an elongated, continuous arcuate shape, alternating between a plurality of concave portions and a plurality of convex portions between the first end and the second end; and
a plurality of thatch fibers which comprise a first longitudinal surface, a second longitudinal surface opposite the first longitudinal surface, a first end connecting the first longitudinal surface and the second longitudinal surface, a second end opposite the first end the first longitudinal surface and the second longitudinal surface, and a top surface, wherein the shape of the face fiber first longitudinal surface is different from the shape of the thatch fiber first longitudinal surface.

2. The artificial turf of claim 1 comprising 100% nylon, wherein the nylon has not been chemically modified.

3. The artificial turf of claim 1 wherein the face fiber first longitudinal surface and the face fiber second longitudinal surface, adjacent each of the first end portion and the second end portion, are concave.

4. The artificial turf of claim 1 wherein the face fiber first end portion and the face fiber opposite second end portion extend convexly outwardly in a longitudinal direction between the first end portion and the second end portion.

5. The artificial turf of claim 4 wherein the convex portions of the face fiber first longitudinal surface and the face fiber second longitudinal surface extend outwardly in a direction which is perpendicular to the longitudinal direction.

6. The artificial turf of claim 1 wherein the convex portions of the face fiber first longitudinal surface are disposed opposite a convex portion of the face fiber second longitudinal surface.

7. The artificial turf of claim 1 wherein the convex portions and the concave portions of the face fiber first longitudinal surface and the face fiber second longitudinal surface are symmetrical.

8. The artificial turf of claim 1 wherein the face fiber first longitudinal surface comprises nine convex portions between the first end and the second end.

9. The artificial turf of claim 1 wherein the width of the face fiber is about one and a half times that of the thatch fiber.

10. The artificial turf of claim 1 wherein the thatch fiber first end portion and the thatch fiber opposite second end portion extend convexly outwardly in a longitudinal direction between the first end portion and the second end portion.

11. The artificial turf of claim 10 comprising at least one first linear angular protrusion extending along the thatch fiber first longitudinal surface in a direction which is perpendicular to the longitudinal direction.

12. The artificial turf of claim 11 wherein the first linear angular protrusion is generally triangular.

13. The artificial turf of claim 11 comprising at least one second linear angular protrusion extending along the thatch fiber second longitudinal surface in a direction which is perpendicular to the longitudinal direction.

14. The artificial turf of claim 13 wherein the at least one first linear angular protrusion and the at least one second linear angular protrusion are symmetrically aligned.

15. The artificial turf of claim 11 comprising at least one thatch fiber first convex portion extending along the thatch fiber first longitudinal surface in a direction which is perpendicular to the longitudinal direction and at least one thatch fiber second convex portion extending along the thatch fiber second longitudinal surface in a direction which is perpendicular to the longitudinal direction.

16. A spinneret comprising an opening configured to extrude a face fiber, wherein a perimeter of the opening comprises:
a first longitudinal surface, a second longitudinal surface opposite the first longitudinal surface, a first end connecting the first longitudinal surface and the second longitudinal surface, a second end opposite the first end the first longitudinal surface and the second longitudinal surface, wherein:
the first end and the second end are convex; and
the first longitudinal surface and the second longitudinal surface each comprise an elongated, continuous arcuate shape, alternating between a plurality of concave portions and a plurality of convex portions between the first end and the second end.

17. The spinneret of claim 16 wherein a distance between the plurality of first longitudinal surface convex portions and the plurality of second longitudinal surface convex portions is between about 0.001 and 0.100 inches.

18. The spinneret of claim 16 wherein a distance between the plurality of first longitudinal surface convex portions and the plurality of second longitudinal surface convex portions is between about 0.025 and 0.033 inches.

19. The spinneret of claim 16 wherein a distance between the first end and the second end is between about 0.070 to 0.250 inches.

20. The spinneret of claim 16 wherein a distance between the first end and the second end is between about 0.109 to 0.180 inches.

21. An artificial turf product comprising:
a plurality of face fibers comprising between about 300 and 2500 denier;
a plurality of thatch fibers comprising between about 300 and 2500 denier;
and a backing material, wherein plurality of face fibers and the plurality of thatch fibers each consist of:
nylon which has not been chemically modified; and
a color component.

22. The artificial turf product of claim 21 wherein the plurality of face fibers comprise between about 600 and 2000 denier and the plurality of thatch fibers comprise between about 600 and 2000 denier.

23. The artificial turf product of claim 21 additionally comprising a fill material.

24. The artificial turf product of claim 21 wherein the turf product is tufted.

25. The artificial turf product of claim 21 wherein the melting point of the turf product is above 420 degrees Fahrenheit.
